(19) United States
(12) Patent Application Publication
(10) Pub. No.: US 2008/0283270 A1
(43) Pub. Date: Nov. 20, 2008

(54) Protective Sheath Against Radiation, in Particular Derived from Electric Field Generated by Electric Cables

(75) Inventor: Christian Aumoitte, Ecquevilly (FR)

Correspondence Address: YOUNG & THOMPSON, 745 South 23rd Street, Second Floor, Arlington, VA, 22202, US

(73) Assignee: Rayponse, Ecquevilly (FR)

(21) Appl. No.: 11/631,504

(22) PCT Filed: Jul. 8, 2005
(86) PCT No.: PCT/FR2005/001766

§ 371 Date: Jan. 4, 2007

(30) Foreign Application Priority Data
Jul. 8, 2004 (FR) 0407615

(51) Int. Cl. H01B 7/18

(52) U.S. Cl. 174/107

(57) ABSTRACT

The invention concerns a protective sheath against radiation, in particular derived from electric field generated by electric cables (1, 2, 3) extending inside the sheath. The invention is characterized in that it comprises an electrically insulating plastic outer layer (4) covering an electrically conductive material layer (5), the sheath end including removable connecting means for connecting the electrically conductive material layer (5) to an electrical conductor (7) designed to be connected to the ground, said sheath enclosing or designed to enclose at least one neutral cable (1), one ground cable (2) and one phase cable (3) connected to an electric power distribution system.

The present invention relates to a protective sheath against radiation, in particular derived from the electric field generated by electric cables extending inside the sheath, for example of the ICTA or ICTL type.

So-called “shielded” cables are known which are used in order to transmit high-frequency telecommunications signals either by means of a copper conductor, or by means of an optical fibre, etc. The shielding is generally produced using a braid made of a conductive metal wire which is separated from the conductive wire or from the optical fibre by a layer of insulating plastic material, and is surrounded on the outside by another layer of insulating plastic material.

At present, protective sheaths, called ICTA, ICTL sheaths, etc., are commonly used in the building industry, the external surface of which is smooth or corrugated in order to give them a certain flexibility whilst reinforcing their resistance to deformation. These sheaths have no shielding against radiation, and in particular against the electric fields.

These protective sheaths receive several electric cables, generally a neutral cable, an earth cable and a phase cable connected to the electric distribution network the frequency of which is usually 50 Hz.

The cables are intended to supply power to various devices or power outlets.

These cables generate an electric field which can interfere with certain devices, or even cause health problems.

The aim of the present invention is to remedy these drawbacks by creating a protective sheath against radiation, in particular against the electric field, generated by electric cables of the above type.

According to the invention, this sheath is characterized in that it comprises an external layer of electrically insulating plastic material which covers a layer made of electrically conductive material, the end of the sheath comprising removable connection means for connecting the layer of electrically conductive material to an electrical conductor intended to be connected to earth, said sheath surrounding or being intended to surround at least one neutral cable, an earth cable and a phase cable connected to the electric distribution network.

The intermediate layer of conductive material connected to earth very greatly attenuates the radiation towards the outside of the electric field generated by the cables extending inside the sheath.

In one embodiment, the conductor intended to be connected to earth extends longitudinally between the conductive layer and an internal insulating layer.

The conductive layer can be a sheet made of conductive metal extending annularly or helically between the external insulating layer and the internal insulating layer. This sheet of conductive metal can be a sheet of aluminium, of mumetal, etc.

However, the layer of conductive material is preferably a polymer loaded with conductive powder such as graphite.

Consequently, the different layers can be coextruded.

Also preferably, the sheath is corrugated on the outside and on the inside, which allows it to be bent and easily cut up as required.

Other characteristics and advantages of the invention will also become apparent in the description below.

In the attached drawings, given by way of non-limitative examples:

FIG. 1 is a cross-section view of a first version of an anti-radiation sheath according to the invention,

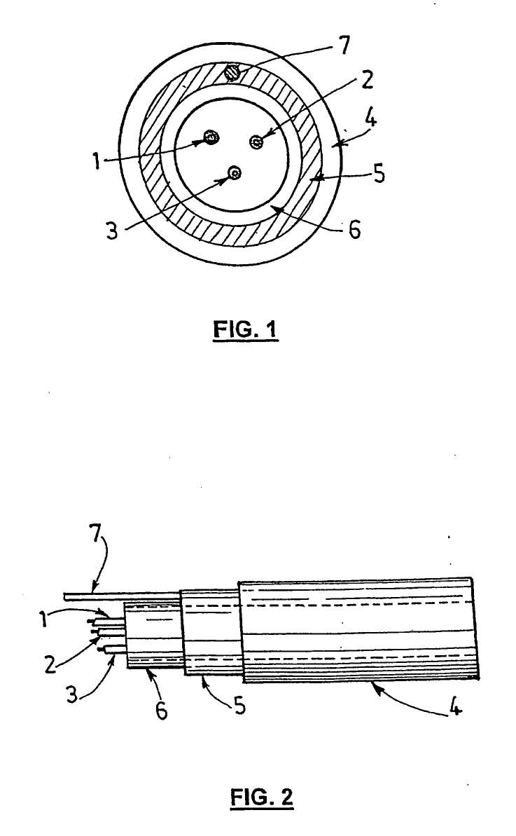

FIG. 2 is a longitudinal view with cut-aways of the sheath according to FIG. 1,

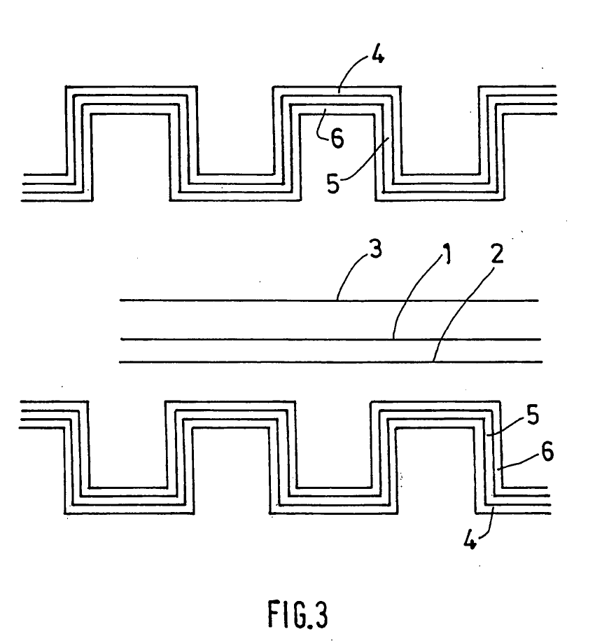

FIG. 3 is a diagrammatic view in longitudinal section of a sheath according to the invention, corrugated and composed of three layers,

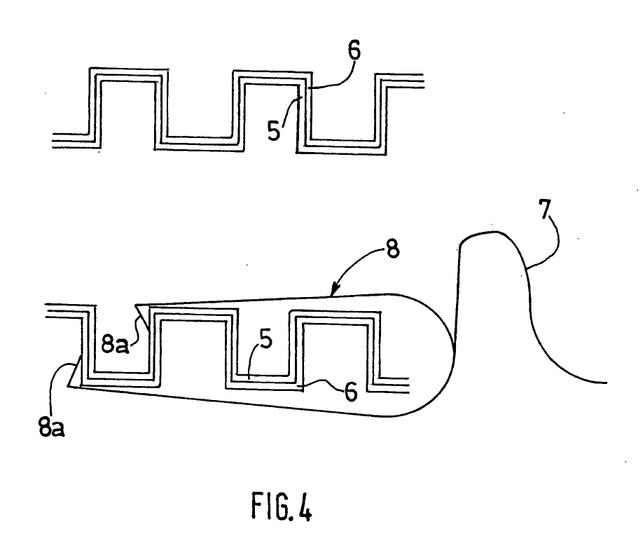

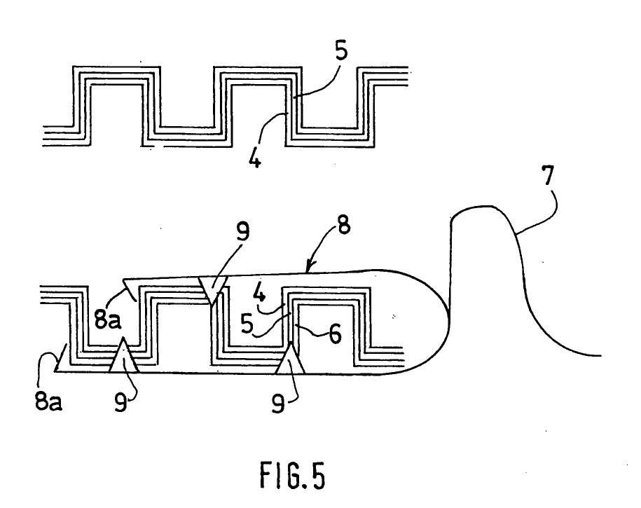

FIG. 4 is a similar view to FIG. 3, the sheath having two layers and its end comprising a connection clip,

FIG. 5 is a similar view to FIG. 4, the sheath comprising 3 layers,

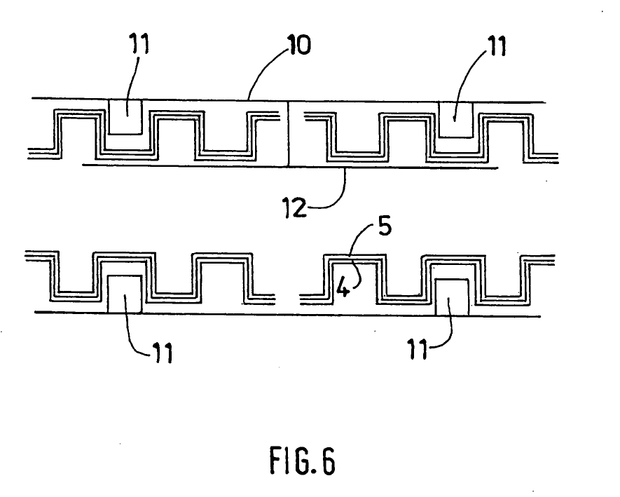

FIG. 6 is a longitudinal cross-section view of two sections of a sheath with two layers, connected by means of a sleeve,

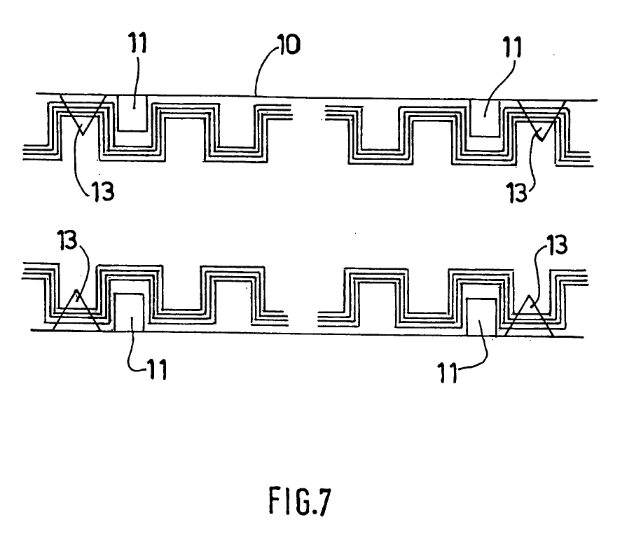

FIG. 7 is a view similar to FIG. 6, the sheath having three layers.

FIGS. 1 and 2 show a protective sheath against radiation, in particular against the electric field generated by electric cables 1, 2, 3 extending inside the sheath.

The sheath comprises an external layer 4 of electrically insulating plastic material, an intermediate layer 5 of electrically conductive material, an internal layer 6 of electrically insulating material, an electric conductor 7 intended to be connected to earth which is connected to the intermediate layer 5 of conductive material. This sheath surrounds or is intended to surround a neutral cable 1, an earth cable 2 and, at least one phase cable 3 connected to the electric distribution network the frequency of which is usually 50 Hz.

In the example represented the conductor 7 intended to be connected to earth is a bare conductive wire, for example of copper. It extends longitudinally between the conductive intermediate layer 5 and the internal insulating layer 6.

The intermediate conductive layer 5 can be a sheet of conductive metal, such as a sheet of aluminium extending annularly or helically between the external insulating layer 4 and the internal insulating layer 6.

The external and internal insulating layers 4, 6 can be made of a plastic material of the same quality as the standard sheaths currently used in the building industry, such as polypropylene, polyethylene or PVC.

The external diameter of the sheath can vary according to the ranges which currently exist for standard unprotected sheaths.

The thickness of these layers 4, 6 is of the order of 0.1 mm.

The intermediate layer 5, when it is constituted by a sheet of aluminium, can be very thin: approximately 1/100^{th} of a mm.

The above sheath can be produced in several stages:
application onto an internal insulating sheath of a sheet of aluminium then application onto the latter of an external insulating layer.

The sheath can also be produced in a single stage by moulding from a casting or similar.

The sheath could be slit in the direction of its length in order to allow or facilitate the placement of the cables according to the application considered.

FIGS. 3 to 7 represent preferred embodiments of the protective sheath according to the invention. As in the embodiment described previously, the sheath comprises an external layer 4 of an electrically insulating plastic material which covers a layer 5 of electrically conductive material. Moreover, the end of the sheath comprises (see FIGS. 4 and 5) removable connection means for connecting the layer 5 of electrically conductive material to an electric conductor 7 intended to be connected to earth.

In these examples, the layer 5 of conductive material is made of polymer loaded with conductive powder, such as graphite. The polymer contains for example, from 5 to 40% graphite. In the example of FIGS. 3, 5 and 7, the layer 5 made of polymer loaded with conductive powder is comprised between the external insulating layer 4 and an internal insulating layer 6.

In the example of FIGS. 4 and 6, there are only two layers. In both cases, the sheath is corrugated on the outside and on the inside, which allows it to be rigid, flexible and easily cut up into sections of desired length.

In the embodiments represented in FIGS. 4 and 5, the removable connection means for connecting the layer 5 of electrically conductive material to an electric conductor 7 intended to be connected to earth include a conductive clip 8 connected to the electric conductor 7 which is able to electrically clip onto one end of the wall of the sheath. The ends of the clip 8 comprise, for this purpose, locking jaws 8a which are able to lock onto a ring outside and/or inside the sheath.

In the example of FIG. 4, the sheath is composed of two layers, one of them 4 being insulating and the other 5, being conductive. In this case, the conductive clip 8 is in direct contact with the layer 5 and thus establishes the electric connection with the conductive layer 5.

When the conductive layer 5 is composed of three layers (see FIG. 5) and is situated between two insulating layers 4, 6, the clip 8 comprises, in addition, sharp and pointed wedges 9 which are able to pierce the wall of the sheath in order to establish an electric connection with the conductive layer 5, thanks to the elastic bearing force exerted by the two arms of the clip 8.

In the case of FIGS. 6 and 7, a sleeve 10 is provided in order to connect the ends of two sheath sections. This sleeve 10 is able to engage onto the ends of these two sheath sections, and comprises on its internal surface holding catches 11 which are able to engage between two external rings of each of the two sheath sections.

Means are also provided for establishing the electric connection between the conductive layers 5 of the two sheath sections.

When the sheath is made up of two layers (see FIG. 6), one of them 4 being insulating, and the other 5, being conductive, the above-mentioned connection means comprise a flexible conductor 12 connecting the conductive layers 5 of the two sheath sections together.

When the sheath (see FIG. 7) is composed of three layers, the conductive layer 5 being situated between two insulating layers 4, 6, the connecting sleeve 10 also has, on its internal surface sharp and pointed pins 13, which are able to pierce the wall of each sheath section in order to establish an electric connection between the conductive layers 5 of the two sheath sections.

The sheath which has just been described has the following main advantages:
Thanks to its corrugated structure, the sheath is flexible, bendable and easy to cut up as required.
Moreover, the sheath is impermeable to liquids, in particular water and concrete laitance. It can thus be immersed in concrete.

The preferred sheath according to FIGS. 3 to 7 can be economically produced, from polypropylene for example and by simultaneous coextrusion of several layers.

The sleeve 10 represented in FIGS. 6 and 7, makes it possible to easily connect two sheath sections while ensuring the continuity of the conductive layer.

Moreover, the end clips 8 make it possible to easily connect the conductive layer of the sheath to a conductive wire intended to be connected to earth.

1. Protective sheath against radiation, in particular against the electric field generated by electric cables (1, 2, 3) extending inside the sheath, characterized in that it comprises an external layer (4) of electrically insulating plastic material which covers a layer (5) of electrically conductive material, the end of the sheath comprising removable connection means for connecting the layer (5) of electrically conductive material to an electric conductor (7) intended to be connected to earth, said sheath surrounding or being intended to surround at least one neutral cable (1), an earth cable (2) and a phase cable (3) connected to the electric distribution network.

2. Sheath according to claim 1, characterized in that the conductor (7), intended to be connected to earth, extends longitudinally between the conductive layer (5) and an internal insulating layer (6).

3. Sheath according to claim 1, characterized in that the conductive layer (5) is a sheet of conductive metal extending annularly and helically between the external insulating layer (4) and an internal insulating layer (6).

4. Sheath according to claim 3, characterized in that said sheet is a sheet of aluminium.

5. Sheath according to claim 1, characterized in that the layer (5) of conductive material is made of polymer loaded with a conductive powder.

6. Sheath according to claim 5, characterized in that the conductive powder is graphite.

7. Sheath according to claim 5, characterized in that the layer (5) of polymer loaded with conductive powder is comprised between the external insulating layer (4) and an internal insulating layer (6).

8. Sheath according to claim 5, characterized in that it is corrugated on the outside and on the inside.

9. Sheath according to claim 8, characterized in that the removable connection means for connecting the layer (5Y of electrically conductive material to an electric conductor (7) intended to be connected to earth, comprises a conductive clip (8) connected to said electric conductor (7) which is able to elastically clip onto one end of the wall of the sheath, the ends of the clip (8) being able to lock onto to a ring outside and/or inside the sheath.

10. Sheath according to claim 9, characterized in that, when it is composed of two layers, one of them (4) being insulating and the other (5), being conductive, the conductive clip (8) is in direct contact with the conductive layer (5) and thus establishes the electric connection with the conductive layer (5).

11. Sheath according to claim 9, characterized in that, when it is composed of three layers, the conductive layer (5) being situated between two insulating layers (4, 6) said clip (8) comprises sharp and pointed pins (9) which are able to piece the wall of the sheath in order to establish an electric connection with the conductive layer (5).

12. Sheath according to claim 8, characterized in that it comprises a sleeve (10) for connecting the ends of two sheath sections, this sleeve (10) being able to engage onto the ends of these two sections and comprising on its internal surface holding catches (11) which are able to engage between two external rings of each of the two sections, means also being provided for establishing the electric connection between the conductive layers (5) of the two sections.

13. Sheath according to claim 12, characterized in that, when it is composed of two layers, one of them (4) being insulating and the other (5), being conductive, said means comprise a flexible conductor (12) connecting the conductive layers (5) of the two sections together.

14. Sheath according to claim 12, characterized in that, when it is composed of three layers, the conductive layer (5) being situated between two insulating layers (4, 6), the sleeve (10) also has, on its internal surface, sharp and pointed pins (9) which are able to pierce the wall of each sheath section in order to establish an electric connection between the conductive layers (5) of the two sections.
